(19) United States
(12) Patent Application Publication
(10) Pub. No.: US 2026/0167178 A1
(43) Pub. Date: Jun. 18, 2026

(54) METHOD AND APPARATUS FOR CONTROLLING VEHICLE HEADING AND TIRE ALIGNMENT DURING PARKING

(71) Applicants: HYUNDAI MOTOR COMPANY, Seoul (KR); KIA CORPORATION, Seoul (KR)

(72) Inventors: Yun Sik Kim, Hwaseong-si (KR); Sang Yol Yoon, Hwaseong-si (KR)

(73) Assignees: HYUNDAI MOTOR COMPANY, Seoul (KR); KIA CORPORATION, Seoul (KR)

(21) Appl. No.: 19/396,874

(22) Filed: Nov. 21, 2025

(30) Foreign Application Priority Data
Dec. 17, 2024 (KR) 10-2024-0188310

(51) Int. Cl. B60W 30/06; B60W 40/02

(52) U.S. Cl. CPC B60W 30/06; B60W 40/02; B60W 2510/20; B60W 2540/18

(57) ABSTRACT

A method for simultaneously controlling vehicle heading and tire alignment includes parking a vehicle at a target parking position within a target parking zone, based on vehicle state information and parking environment information, by generating at least one parking path for parking the vehicle. The method further includes determining whether to perform on-center control on the vehicle. The method further includes obtaining an on-center alignment time of a steering wheel. The method further includes calculating a target heading that represents a difference between an exit direction from the target parking zone and a longitudinal direction of the vehicle. The method further includes calculating a heading change amount of the vehicle until an on-center alignment time of the steering wheel, based on a current yaw rate of the vehicle. The method further includes performing the on-center control.

### CROSS-REFERENCE TO RELATED APPLICATION

The present application claims the benefit of and priority to Korean Patent Application No. 10-2024-0188310, filed on Dec. 17, 2024 in the Korea Intellectual Property Office, the entire contents of which are incorporated herein by reference.

### TECHNICAL FIELD

The present disclosure relates to a method and an apparatus for simultaneously controlling vehicle heading and tire alignment to reduce parking time.

### BACKGROUND

The statements in this section merely provide background information related to the present disclosure and do not necessarily constitute prior art.

FIG. 1 is a diagram illustrating a parking path control and tire alignment process in a conventional parking control method.

As shown in FIG. 1, in a conventional parking controller, a parking path for an own vehicle 110 is planned, and a reverse path 121 is generated to align vehicle heading, allowing the own vehicle 110 to enter a parking zone 120. After the own vehicle 110 enters the target parking zone 120, a tire 111 of the own vehicle 110 is rotated by a required angle 122 to align the tire 111 so that the tire 111 faces in the same direction as the heading direction of the vehicle 110, following a sequential sequence.

However, in FIG. 1, there is a problem that the parking time becomes longer because additional time is required to align the tire 111 after the parking path is controlled.

FIG. 2 is a diagram illustrating a parked shape when the own vehicle reaches a parking completion point.

In the conventional parking controller, even if the parking completion point is reached as shown in FIG. 2 through path-following lateral control, additional time is required to align the tire 111 of the own vehicle 110. In addition, if a small error (e.g., 30) occurs in the heading angle of the own vehicle 110, a problem may occur in which a lateral error (e.g., 32 cm) becomes excessive in a bumper line of the front of the own vehicle 100 even if the lateral error at a rear axle of the own vehicle 110 is small.

In order to improve the problem of excessive lateral error in the front bumper line 112 as shown in FIG. 2, there is a problem that additional heading alignment control is required after parking control.

### SUMMARY

An object of the present disclosure aims to provide a method and an apparatus for simultaneously controlling vehicle heading and tire alignment to reduce parking time.

The technical objects of the present disclosure are not limited to those described above, and other technical objects not mentioned above may be understood clearly by those having ordinary skill in the art from the present disclosure.

An embodiment of the present disclosure provides a method for simultaneously controlling vehicle heading and tire alignment. The method includes parking a vehicle at a target parking position within a target parking zone, based on vehicle state information and parking environment information, by generating at least one parking path for parking the vehicle. The method further includes determining whether to perform on-center control on the vehicle, based on whether the vehicle is capable of reaching the target parking position via a final reverse path among the at least one parking path. The method further includes obtaining an on-center alignment time of a steering wheel based on whether the vehicle is capable of reaching the target parking position. The method further includes calculating a target heading that represents a difference between an exit direction from the target parking zone and a longitudinal direction of the vehicle. The method further includes calculating a heading change amount of the vehicle until an on-center alignment time of the steering wheel, based on a current yaw rate of the vehicle. The method further includes performing the on-center control according to a reverse path for on-center alignment, based on the heading change amount and the target heading.

Another embodiment of the present disclosure provides an apparatus for simultaneously controlling vehicle heading and tire alignment. The apparatus includes at least one memory configured to store instructions; and at least one processor. The at least one processor is configured, by executing the instructions, to park a vehicle at a target parking position within a target parking zone, based on vehicle state information and parking environment information, by generating at least one parking path for parking the vehicle. The at least one processor is further configured to determine whether to perform on-center control on the vehicle, based on whether the vehicle is capable of reaching the target parking position via a final reverse path among the at least one parking path. The at least one processor is further configured to obtain an on-center alignment time of a steering wheel based on whether the vehicle is capable of reaching the target parking position. The at least one processor is further configured to calculate a target heading that represents a difference between an exit direction from the target parking zone and a longitudinal direction of the vehicle. The at least one processor is further configured to calculate a heading change amount of the vehicle until an on-center alignment time of the steering wheel, based on a current yaw rate of the vehicle. The at least one processor is further configured to perform the on-center control according to a reverse path for on-center alignment, based on the heading change amount and the target heading.

According to one embodiment of the present disclosure, time required to realign a tire after controlling a parking path is reduced because heading alignment and tire alignment of an own vehicle are simultaneously performed.

According to one embodiment of the present disclosure, by introducing a series of sequences to simultaneously align three targets, i.e., longitudinal, lateral, and vehicle heading, at a parking end position, the parking time of an own vehicle is reduced and a total contour error of the own vehicle is reduced.

The technical effects of the present disclosure are not limited to the technical effects described above, and other technical effects not mentioned herein may be understood to those having ordinary skill in the art to which the present disclosure belongs from the present disclosure.

### BRIEF DESCRIPTION OF THE DRAWINGS

FIG. 1 is a diagram illustrating a parking path control and tire alignment process in a conventional parking control method.

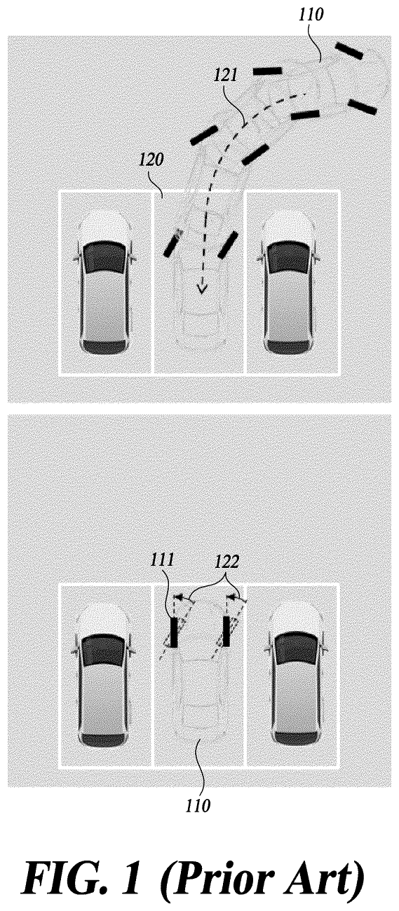

FIG. 2 is a diagram illustrating a parked shape when an own vehicle reaches a parking completion point.

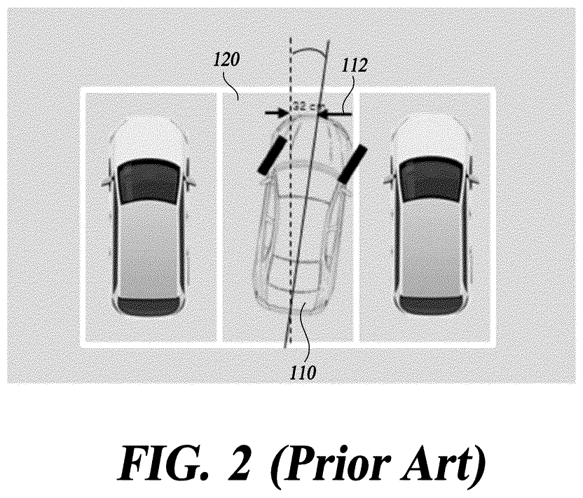

FIG. 3 is a block diagram showing a parking control device 300 according to one embodiment of the present disclosure.

FIG. 4 is a diagram illustrating a situation in which the own vehicle 110 enters a target parking zone.

FIG. 5 is an S motion steering graph.

FIG. 6 is a diagram illustrating a situation in which the own vehicle is parked according to the S motion steering.

FIG. 7 is a diagram showing a lateral correction amount required for S motion steering.

FIG. 8 is a diagram showing examples of cases where the target parking zone has a wide or narrow width.

FIG. 9 is a flowchart illustrating a parking control method according to one embodiment of the present disclosure.

FIG. 10 is a block diagram illustrating a computing device that may be used for implementing a method or an apparatus according to one embodiment of the present disclosure.

FIG. 11 is a block diagram schematically illustrating an example vehicle that can be used to implement the method or device according to one embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the accompanying drawings. In the present disclosure, like reference numerals designate like elements, although the elements are shown in different drawings. Further, in the present disclosure, a detailed description of known functions and configurations incorporated therein has been omitted for the purpose of clarity and for brevity.

Additionally, various terms, such as first, second, A, B, (a), (b), etc., are used solely to differentiate one component from the other but are not intended to imply or suggest the substances, order, or sequence of the components. Throughout the present disclosure, when a part ‘includes’ or ‘comprises’ a component, the part is meant to further include other components is not intended to exclude thereof unless specifically stated to the contrary. The terms, such as ‘unit’, ‘module’, and the like, refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe embodiments of the present disclosure, and is not intended to represent the only embodiments in which the present disclosure may be practiced.

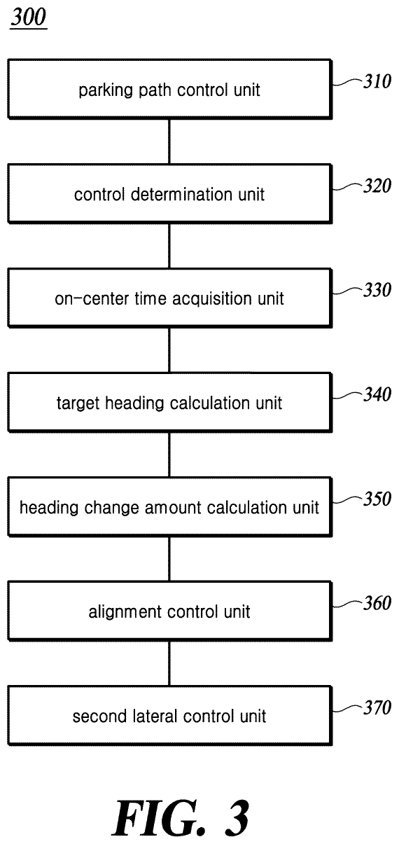

FIG. 3 is a block diagram showing a parking control device 300 according to one embodiment of the present disclosure.

The parking control device 300 according to one embodiment of the present disclosure includes a parking path control unit 310, a control determination unit 320, an on-center time acquisition unit 330, a target heading calculation unit 340, a heading change amount calculation unit 350, an alignment control unit 360, and a second lateral control unit 370. Not all blocks illustrated in FIG. 3 are essential components, and some blocks included in the parking control device 300 may be added, changed, or deleted in other embodiments. Meanwhile, components illustrated in FIG. 3 represent functionally distinct elements, and one or more components may be implemented to be integrated with each other in an actual physical environment.

The parking path control unit 310 generates at least one parking path to park the own vehicle 110 in a target parking position of a target parking zone 120 based on vehicle state information and parking environment information for parking the own vehicle 110 and then executes parking.

Here, the vehicle state information includes the position, contour, heading, current steering angle, and kinematic constraints of the own vehicle 110. The contour represents a planar size when viewed from above toward the own vehicle 110 below, the heading means the forward direction of the own vehicle 110 in the direction of the entire length of the own vehicle 110, and the kinematic constraints include the minimum turning radius of a vehicle and steering angle limits.

The parking environment information includes the target parking position, the size of the target parking zone, the heading of the target parking zone, a road width, an obstacle, etc. Here, the heading of the target parking zone means a direction in which a vehicle exits the target parking zone.

The parking path control unit 310 generates at least one parking path for parking the own vehicle 110 at the target parking position using a proportional-integral-differential (PID) control method, a model predictive control (MPC) method, or the like and executes parking of the own vehicle 110 according to the generated parking path.

At least one parking path includes at least one forward path and at least one reverse path of the own vehicle 110 required to park the own vehicle 110 at the target parking position. In the following description, it is assumed that at least one parking path is a plurality of parking paths including at least one forward path and at least one reverse path.

Further, the parking path may be generated using an artificial neural network based on the vehicle state and parking environment information of the own vehicle 110.

Specific details on a specific method for generating the parking path based on the vehicle state and parking environment information of the own vehicle 110 are beyond the scope of the present disclosure, so further detailed description thereof is omitted.

The control determination unit 320 determines whether to perform on-center control on the own vehicle 110 based on whether the own vehicle 110 may reach the target parking position by a final reverse path among the plurality of parking paths.

The final reverse path refers to a parking path generated for executing the final reverse drive, in a state where only the execution of the final reverse drive remains in the process of parking by driving through multiple parking paths.

The on-center control means controlling a reverse parking path by adding the steering wheel on-center condition of the own vehicle 110 to the vehicle state information. In other words, it means controlling the reverse parking path so that the steering wheel of the own vehicle 110 is positioned on-center (i.e., target steering angle=0°) at the time the reverse path driving is completed. Details on the on-center control are described below.

The control determination unit 320 determines whether to perform on-center control based on whether the own vehicle 110 may reach a lateral position range within a preset lateral error from the target parking position.

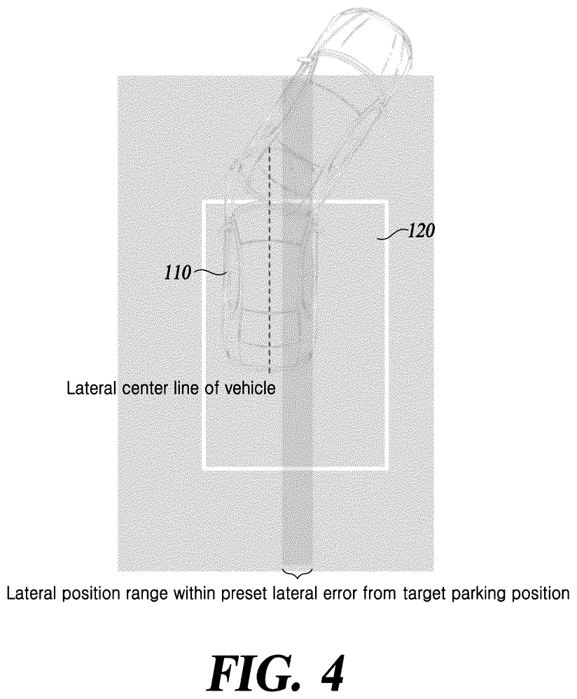

FIG. 4 is a diagram illustrating a situation in which the own vehicle 110 enters the target parking zone.

In FIG. 4, when a lateral center line within the target parking zone 120 is set as the target parking position, a lateral position range within a preset lateral error from the target parking position is set.

As shown in FIG. 4, when it is predicted that the lateral center line of the own vehicle 110 deviates from the lateral position range within the preset lateral error from the target parking position, the control determination unit 320 determines that the own vehicle 110 may not reach the lateral position range within the preset lateral error from the target parking position.

If it is predicted that the lateral center line of the own vehicle 110 does not deviate from the lateral position range within the preset lateral error from the target parking position, the control determination unit 320 determines that the own vehicle 110 may reach the lateral position range within the preset lateral error from the target parking position. In other words, the fact that the lateral center line of the own vehicle 110 does not deviate from the lateral position range within the preset lateral error from the target parking position means that the lateral error of the own vehicle 110 from the target parking position by the final reverse path exists within the preset lateral position range.

When the control determination unit 320 determines that the own vehicle 110 may reach the target parking position by the final reverse path, the on-center time acquisition unit 330 acquires the on-center alignment time of the steering wheel of the own vehicle 110.

The on-center time acquisition unit 330 acquires the on-center alignment time according to a steering speed up to an on-center alignment point.

The on-center alignment time (hereinafter referred to as first alignment time) of the steering wheel may be calculated by dividing a current steering angle by the steering speed until the on-center alignment point. The steering speed up to the on-center alignment point may be applied as an average of steering speeds from the current point in time to the on-center alignment point of the steering wheel or may be applied as the current steering speed depending on an embodiment.

The on-center alignment point refers to a point in time when the steering angle becomes 0° after steering is performed from the current steering angle of the steering wheel of the own vehicle 110.

The average steering speed may be calculated according to a steering speed profile, and the steering speed profile may be obtained according to the current steering angle, the heading of the own vehicle 110, the heading of the target parking zone 120, the speed of the own vehicle 110, etc.

Because specific details regarding the acquisition of the steering speed profile at a current point are beyond the scope of the present disclosure, further detailed description thereof is omitted.

The target heading calculation unit 340 calculates a target heading that represents a difference between the heading of the target parking zone 120 and the heading of the own vehicle 110.

The heading change amount calculation unit 350 calculates the heading change amount of the own vehicle 110 up to the point of on-center alignment based on the yaw rate of the own vehicle 110. The heading change amount calculation unit 350 may calculate a heading change amount ΔH as in Equation 1 by integrating the yaw rate during the on-center alignment time.

$$Δ H = {\int }_{0}^{τ} YawRate ( t ) dt \qquad [ Equation 1 ]$$

Here, YawRate(t) is a yaw rate function represented by a third-order polynomial model of the own vehicle 110 that changes over time, and T represents the on-center alignment time.

The heading change amount ΔH may be calculated by approximating YawRate(t) as a linear expression, as in Equation 2.

$$Δ H = 0 \text{.5} \times {YawRate}_{cur} \times τ \qquad [ Equation 2 ]$$

Here, YawRate_{cur} means a current yaw rate.

In other words, the heading change amount calculation unit 350 calculates the heading change amount by multiplying the on-center alignment time T by the current yaw rate YawRate_{cur}.

The alignment control unit 360 performs on-center control based on the heading change amount and the target heading. In other words, the alignment control unit 360 performs on-center control according to the on-center reverse path when the heading change amount is equal to or greater than a target heading amount.

The alignment control unit 360 continuously compares the heading change amount and the target heading amount while the own vehicle 110 is driving along the final reverse path.

When the alignment control unit 360 compares the heading change amount and the target heading amount and the heading change amount becomes greater than the target heading amount, the alignment control unit 360 performs on-center control and the operation of the parking path control unit 310 is stopped.

The alignment control unit 360 further includes an on-center condition of the steering wheel in the vehicle state information, generates an on-center reverse path according to the vehicle state information and parking environment information, and performs the on-center control to park the vehicle in the target parking zone 120 while controlling the steering wheel to be on-center according to the on-center reverse path.

As such, parking the vehicle in the target parking zone 120 while controlling the steering wheel to be on-center is defined as simultaneous performance of vehicle heading and tire alignment.

The alignment control unit 360 performs the on-center control to generate the on-center reverse path based on information such as the current position of the own vehicle 110, the contour of the own vehicle 110, the heading of the own vehicle 110, the current steering angle, the target steering angle (=0°), the kinematic constraints of the own vehicle 110, the position and size of the target parking zone 120, the heading of the target parking zone 120, and the position of an obstacle.

Here, the on-center control includes three alignments listed below.
Position alignment: Path following control is performed so that the position of the own vehicle 110 is within a certain lateral error in the target parking zone 120.
Heading alignment: Heading alignment control is performed so that the heading of the own vehicle 110 is aligned the heading of the target parking zone within a certain error.
Steering angle alignment: Steering angle reduction control is performed so that the steering angle δ is aligned to 0° (or within a preset angle).

The alignment control unit 360 performs the on-center alignment control, which is a control method that comprehensively applies the above path following control, steering angle reduction control, and heading alignment control.

As the method of the on-center alignment control, for example, an MPC method may be used. The MPC method is a method of calculating optimal control input (acceleration, steering angle) based on a dynamic model of the own vehicle 110 and performs on-center control while making fine adjustment so that the steering angle remains at 0° even after reaching the target position and heading of the own vehicle 110.

In addition, various methods such as the PID control may be used for the on-center control, but specific details on a method of performing the on-center control are beyond the scope of the present disclosure, so further detailed description thereof is omitted.

The second lateral control unit 370 performs the second lateral control according to a remaining distance to the parking end point within the target parking zone, when it is determined that the lateral error of the own vehicle 110 from the target parking position is not within the preset lateral position range by the final reverse path.

The parking end point means a point located a preset distance in front of a stopper within the target parking zone 120 or the end point of the target parking zone 120.

The second lateral control unit 370 calculates the remaining distance to the parking end point within the target parking zone, when the vehicle is driving along the final driving path is completed by the parking path control unit 310.

At this time, if the remaining distance is equal to or greater than a preset distance (e.g., 4 m), the second lateral control unit 370 generates the second reverse path to move the own vehicle 110 to the parking end point and performs the second lateral control to park the own vehicle 110 along the second reverse path.

The second lateral control unit 370 further includes the current lateral error and the remaining distance to the parking end point in the vehicle state information.

The second lateral control unit 370 generates the second reverse path using PID control or MPC according to vehicle state information and parking environment information. The second lateral control unit 370 parks the own vehicle 110 along the second reverse path.

The detailed description of specific details regarding the method of performing the second lateral control (i.e., the method in which the second lateral control unit 370 generates the second reverse path using the vehicle state information and the parking environment information to park the own vehicle 110) has been omitted herein.

According to one embodiment, the second lateral control unit 370 may be implemented to control parking of the own vehicle 110 along the final reverse path generated by the parking path control unit 310, instead of generating the second reverse path and controlling parking of the own vehicle 110 according to the second reverse path.

If the remaining distance is less than a preset distance and lateral control is performed using a conventional method (e.g., parking control according to the final reverse path), the heading error of the own vehicle 110 may be excessive at the parking end point.

If the remaining distance is less than the preset distance, the second lateral control unit 370 performs S motion lateral control to park the own vehicle 110 at the parking end point.

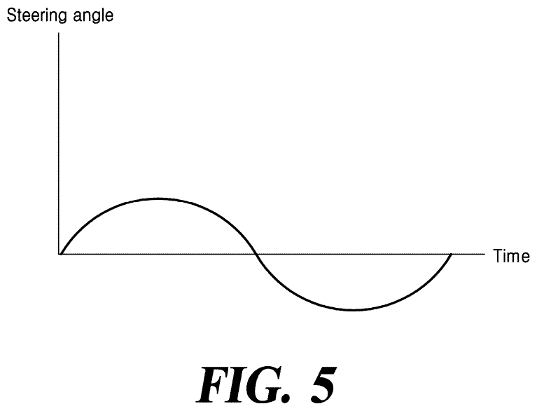

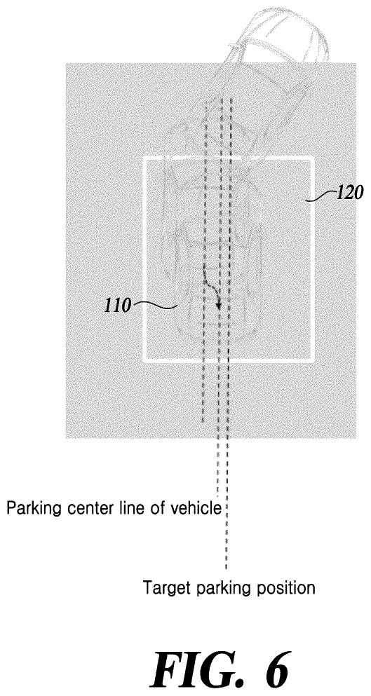

FIG. 5 is an S motion steering graph, and FIG. 6 is a diagram illustrating a situation in which the own vehicle is parked according to the S motion steering.

The second lateral control unit 370 controls the steering angle to control the own vehicle 110 in an S-shaped motion and parks the own vehicle 110 at the parking end point so that the lateral error is minimized.

As shown in FIG. 5, when the steering wheel is steered to the left (steering angle +) once and to the right (steering angle −) once to control parking of the vehicle 110, the heading of the vehicle 110 after parking control is the same as the heading before control, but the lateral error of the vehicle 110 may be reduced. This is because when the steering angle is integrated with respect to time until the parking end point, the result is close to 0.

The parking center line of the vehicle 110 is a point at which a slight lateral error occurs from the target parking position located at the lateral center point of the target parking zone by the S-motion steering control by the second lateral control unit 370.

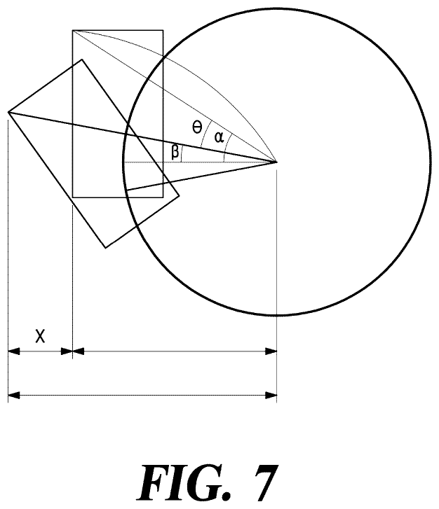

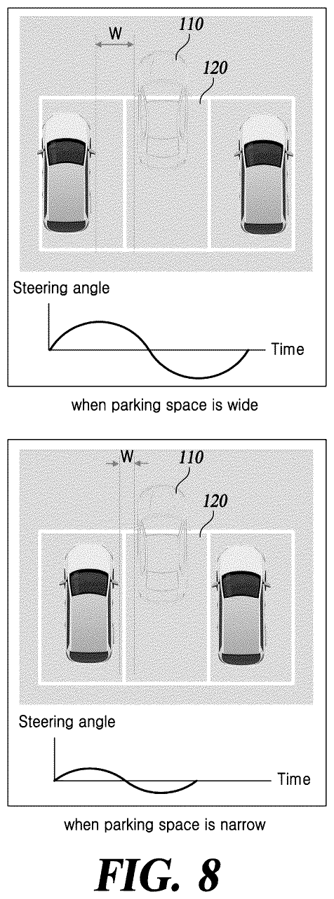

FIG. 7 is a diagram showing a lateral correction amount required for S motion steering, and FIG. 8 is a diagram showing examples of cases where the target parking zone has a wide or narrow width.

The second lateral control unit 370 determines a maximum steering angle during S motion lateral control of the own vehicle 110 according to the distance from a vehicle on the left side of the target parking zone 120 or the distance from a vehicle on the right side of the target parking zone 120.

In the case of S-motion lateral control, the front bumper of the vehicle moves left and right like a fish tail depending on the vehicle steering, which may cause collision with the vehicles on either side. Therefore, the lateral steering amount for lateral movement of the own vehicle 110 varies depending on the distance from the left vehicle or the right vehicle from the target parking zone 120, and the lateral error correction amount of the own vehicle 110 varies depending on the lateral steering amount.

The maximum lateral movement distance of the vehicle contour in the fixed steering of the own vehicle 110 is X in FIG. 8, and X may be calculated by Equation 3.

$$\begin{matrix}X = ( L * cos ( β ) ) - ( R + HOAW ) , \\ L = \sqrt{{( R + HOAW )}^{2} + {( OAL - ROH )}^{2}} , \\ β = α - θ , \\ α = {tan}^{- 1} ( ( OAL - ROH ) / ( R + HOAW ) )\end{matrix} \qquad [ Equation 3 ]$$

Here, R is the rotating radius of the rear wheel center of the own vehicle 110, L is the outermost rotating radius of the front bumper of the own vehicle 110, HOAW is ½ of the overall width of the own vehicle 110, OAL is the overall length of the own vehicle 110, ROH is a length from the rear wheel center of the own vehicle 110 to the rear bumper, and θ is the turning angle of the own vehicle 110. For reference, θ may be approximated as the moving distance of the own vehicle 110.

When the distance from the left vehicle (or the distance from the right vehicle) of the target parking zone 120 is W, X is determined to be equal to or less than W. This is summarized as W≥X=(L*cos(β))−(R+HOAW).

In the S motion steering, steering is not performed with a fixed steering angle but is performed in the order of “on center->left steering->on center->right steering” or “on center->right steering->on center->left steering” according to the reverse direction of the own vehicle 110.

The lateral movement amount of the own vehicle 110 through the S motion steering may be determined by approximating the maximum steering angle during S motion steering to 0.5 times the maximum steering angle of the vehicle 110 compared to that during fixed steering.

Therefore, the maximum lateral movement amount during S motion steering can be seen as 0.5 times that during fixed steering, so the final equation becomes W≥X=0.5*[(L*cos(β))−(R+HOAW)].

Here, R is determined by the steering angle and the specification of the vehicle 110, R is determined according to 0, and 0 is determined by the moving distance of the vehicle 110. When the speed of the vehicle 110 is constant, the moving distance is determined according to the moving time.

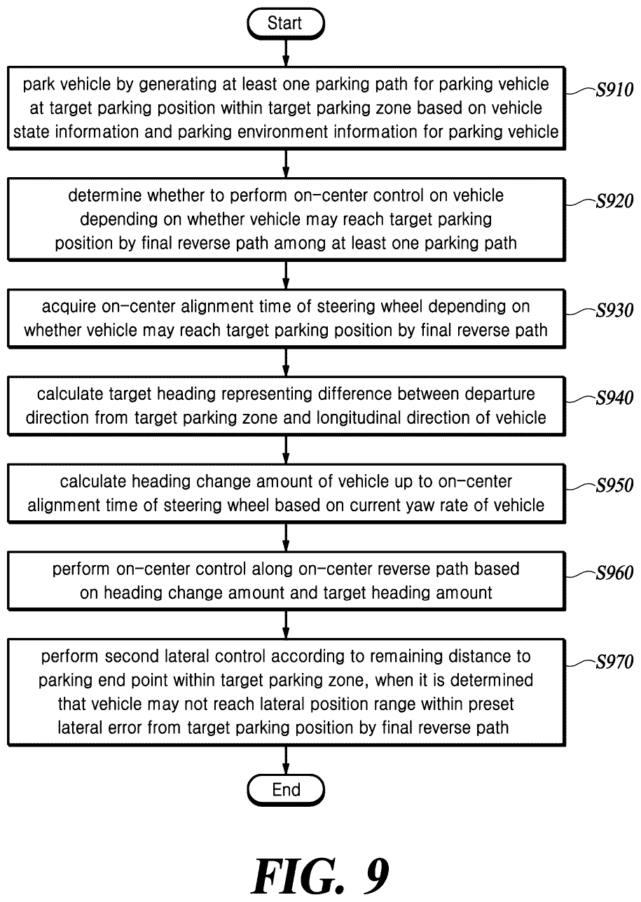

FIG. 9 is a flowchart illustrating a parking control method according to one embodiment of the present disclosure.

The control method according to one embodiment of the present disclosure is performed by the parking control device 300.

The parking path control unit 310 performs a parking path control process for parking the vehicle by generating at least one parking path for parking the vehicle at the target parking position within the target parking zone based on vehicle state information and parking environment information for parking the vehicle 110, in step S910.

The control determination unit 320 performs a control determination process that determines whether to perform on-center control on the vehicle depending on whether the vehicle may reach the target parking position by the final reverse path among at least one parking path, in step S920.

The on-center time acquisition unit 330 performs an on-center time acquisition process to acquire the on-center alignment time of the steering wheel depending on whether the vehicle may reach the target parking position by the final reverse path, in step S930.

The target heading calculation unit 340 performs a target heading calculation process that calculates the target heading representing a difference between the departure direction from the target parking zone 120 and the longitudinal direction of the vehicle, in step S940.

The heading change amount calculation unit 350 performs a heading change amount calculation process that calculates the heading change amount of the vehicle up to the point of on-center alignment of the steering wheel based on the current yaw rate of the vehicle, in step S950.

The alignment control unit 360 performs an alignment control process that performs on-center control along the on-center reverse path based on the heading change amount and target heading amount, in step S960.

If it is determined that the vehicle may not reach a lateral position range within a preset lateral error from the target parking position by the final reverse path, the second lateral control unit 370 performs the second lateral control process of performing the second lateral control according to the remaining distance to the parking end point within the target parking zone, in step S970.

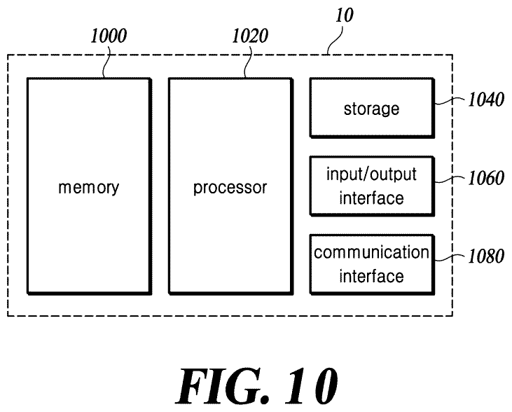

FIG. 10 is a block diagram illustrating a computing device that may be used for implementing a method or an apparatus according to the present disclosure.

The computing device 10 may include all or part of a memory 1000, a processor 1020, a storage 1040, an input/output interface 1060, or a communication interface 1080. The computing device 10 may be a stationary computing device, such as a desktop computer or a server, or a mobile computing device, such as a laptop computer or a smart phone. The computing device 10 may include a specialized hardware accelerator capable of processing operations of an artificial intelligence model in an efficient manner. For example, the computing device 10 may include a graphic processing unit (GPU), a tensor processing unit (TPU), or a neural processing unit (NPU).

The memory 1000 may store a program that enables the processor 1020 to perform methods or operations according to various embodiments of the present disclosure. For example, a program may include a plurality of instructions executable by the processor 1020, and the methods or operations described above may be performed by executing the plurality of instructions by the processor 1020. The memory 1000 may comprise a single memory or a plurality of memories. In this case, information required to perform the methods or operation according to various embodiments of the present disclosure may be stored in a single memory or distributed across a plurality of memories. When the memory 1000 comprises a plurality of memories, the plurality of memories may be physically separated. The memory 1000 may include at least one of volatile memory or non-volatile memory. Volatile memory includes Static Random Access Memory (SRAM) or Dynamic Random Access Memory (DRAM), while non-volatile memory includes flash memory.

The processor 1020 may include at least one core capable of executing at least one instruction. The processor 1020 may execute instructions stored in the memory 1000. The processor 1020 may comprise a single processor or a plurality of processors.

The storage 1040 maintains stored data even if power supplied to the computing device 10 is cut off. For example, the storage 1040 may include non-volatile memory or may include a storage medium, such as a magnetic tape, an optical disk, or a magnetic disk. A program stored in the storage 1040 may be loaded into the memory 1000 before being executed by the processor 1020. The storage 1040 may store files written in a program language, and a program created from the files by a compiler may be loaded into the memory 1000. The storage 1040 may store data to be processed by the processor 1020 and/or data processed by the processor 1020.

The input/output interface 1060 may provide an interface with an input device such as a keyboard or a mouse and/or an output device such as a display device or a printer. The user may trigger execution of a program by the processor 1020 through the input device and/or check the processing results of the processor 1020 through the output device.

The communication interface 1080 may provide access to an external network. The computing device 10 may communicate with other devices through the communication interface 1080.

Each element of the apparatus or the method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium, such as a read-only memory (ROM), a random access memory (RAM), a compact disc ROM (CD-ROM), magnetic tape, a floppy disk, or an optical data storage device. In addition, the computer-readable recording medium may further include a transitory medium, such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of the present disclosure. In other words, those having ordinary skill in the art to which the present disclosure belongs may appreciate that various modifications and changes can be made without departing from essential features of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, those of ordinary skill should understand that the scope of the present disclosure should not be limited by the above explicitly described embodiments but by the claims and equivalents thereof.

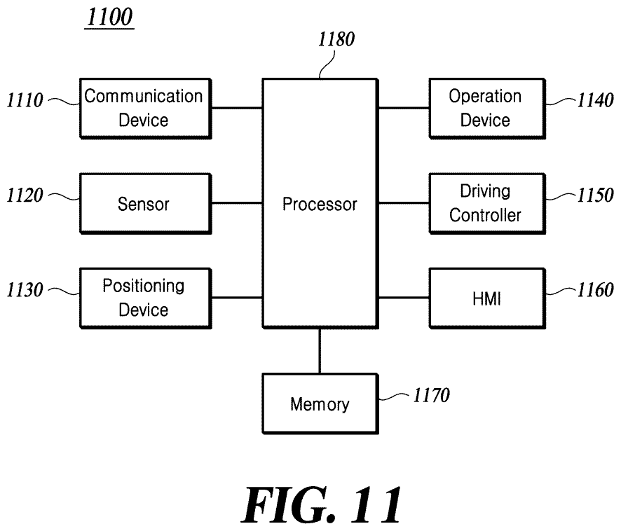

FIG. 11 is a block diagram schematically illustrating an example vehicle that can be used to implement the method or device according to one embodiment of the present disclosure. The vehicle 110 may include at least one of a communication device 1110, a sensor 1120, a positioning device 1130, an operation device 1140, a driving controller 1150, a human machine interface unit (HMI) 1160, a memory 1170, or a controller or processor 1180. The vehicle 110 may include a parking guide line generation control device 300 structurally and/or functionally.

The communication device 1110 may exchange signals with devices positioned outside and inside the vehicle 110. The communication device 1110 may exchange a signal with at least one of an infrastructure device such as a server or a base station, another vehicle, and a terminal. The communication device 1110 may include at least one of a transmission antenna, a reception antenna, a radio frequency (RF) circuit capable of implementing various communication protocols, or an RF element to perform communication. The communication device 1110 may include an internal communication part and an external communication part. The internal communication part may transmit or receive signals using various communication protocols present in the vehicle 110. In this regard, an internal communication protocol may include at least one of a controller area network (CAN), a CAN with flexible data rate (CAN FD), ethernet, local interconnect network (LIN), and FlexRay. The communication protocol may include other protocols for performing communication between various devices mounted on the vehicle. The external communication part may perform communication with other vehicles, an infrastructure system, a base station, or a roadside device using various communication protocols. In this regard, the external communication protocol may include vehicle-to-everything (V2X) communication including vehicle-to-vehicle (V2V) communication, vehicle-to-infrastructure (V2I) communication, vehicle-to-network (V2N) communication, and vehicle-to-pedestrian (V2P) communication. The infrastructure may be, for example, a roadside unit or server that periodically transmits traffic information in conjunction with a transportation information system (TIS) or an intelligent transport system (ITS).

The sensor 1120 may sense the state of the vehicle 110 and an external object. In order to sense the state of the vehicle 110, the sensor 1120 may include at least one of an inertial measurement unit (IMU), a distance measuring instrument (DMI), a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illuminance sensor, or a pedal position sensor. On the other hand, the IMU sensor may include one or more of an acceleration sensor, a gyro sensor, and a magnetic sensor. The sensor 1120 may generate state data of the vehicle, based on a signal generated from at least one sensor. For example, direction information such as the heading and yaw rate of the vehicle 110 may be collected by the sensor 1120.

In order to sense the external object, the sensor 1120 may include at least one of a camera, a radar sensor, a light detection and ranging (LiDAR) sensor, an ultrasonic sensor, or an infrared sensor. The sensor 1120 may measure at least one of information about the presence or absence of an object, information about a position of an object, information about a distance between the vehicle 110 and an object, or information about relative speed between the vehicle 110 and an object.

The positioning device 1130 may generate position data of the vehicle 110. The positioning device 1130 may include at least one of a global positioning system (GPS), a differential global positioning system (DGPS), or a global navigation satellite system (GNSS). The positioning device 1130 may generate the position data of the vehicle 110 based on a signal generated from at least one of the GPS, the DGPS, or the GNSS. The positioning device 1130 may estimate the position of the vehicle 110 based on wireless signals received from the communication device 1110. The positioning device 1130 may estimate the current position of the vehicle 110 based on the previous position, travel distance information, moving time information, speed information, or acceleration information of the vehicle 110 using the IMU or DMI. Meanwhile, the processor 1180 may estimate the path history and path prediction of the vehicle 110 based on the position information of the vehicle 110 collected by the positioning device 1130.

The operation device 1140 receives a user input for driving. In a manual mode, the vehicle 110 may be driven based on a signal provided by the operation device 1140. The operation device 1140 may include a steering input device such as a steering wheel, an acceleration input device such as an accelerator pedal, and a brake input device such as a brake pedal.

The driving controller 1150 is a device that electrically controls various vehicle driving devices in the vehicle 110. The driving controller 1150 may include a power train driving control device, a chassis driving control device, a door/window driving control device, a safety device driving control device, a lamp driving control device, and an air conditioning driving control device. The driving controller 1150 controls the movement of the vehicle 110 based on the input signal of the operation device 1140 or the control signal of the processor 1180.

The HMI 1160 is a device for communication between the vehicle 110 and a human (e.g., an occupant of the vehicle 110 or other vehicle). The HMI 1160 may receive a user input and provide information generated in the vehicle 110 to the user. The vehicle 110 may implement a user interface (UI) or user experience (UX) through the HMI 1160. The HMI 1160 may include an input device such as a touch panel or a microphone, and the HMI 1160 may include an output device such as a display device or a speaker. For example, the HMI 1160 may include an interior display that outputs a screen toward the inside of the vehicle 110 and/or an exterior display that outputs a screen toward the outside of the vehicle.

The memory 1170 may store a program that causes the processor 1180 to perform a method according to an embodiment of the present disclosure. For example, the program may include a plurality of instructions executable by the processor, and the method according to an embodiment of the present disclosure may be performed by executing the plurality of instructions by the processor.

The memory 1170 may be a single memory or a plurality of memories. When the memory 1170 is formed of the plurality of memories, the plurality of memories may be physically separated. The memory 1170 may include at least one of a volatile memory or a non-volatile memory. The volatile memory includes a static random access memory (SRAM) or a dynamic random access memory (DRAM), while the non-volatile memory includes a flash memory.

The memory 1170 may store map information. The map information may be a navigation map and/or a high definition map (HD map). The HD map may be received from an external device or stored in advance. The navigation map includes a node indicating a point where at least two roads meet and a link connecting two nodes. The navigation map may include geographic information, road information, lane information, building information, or signal information. The HD map incorporates more specific data compared to the navigation map. The ADAS map may include road gradient, road curvature, or sign information, based on a road. The HD map may include lane information, lane boundary information, stop line position, traffic light position, signal sequence, or intersection information, based on a lane. The HD map may include basic road information, surrounding environment information, detailed road environment information, or dynamic road condition information. The detailed road environment information may include static information, such as elevation of terrain, curvature, lane, lane centerline, regulation line, road boundary, road centerline, traffic sign, road surface sign, shape and height of the road, lane width, and the like. The dynamic road condition information may include traffic congestion, an accident section, a construction section, and the like. The HD map may include road surrounding environment information implemented in 3D, geometric information such as road shape or facility structure, and semantic information such as traffic signs or lane marks.

The processor 1180 may include at least one core capable of executing at least one command. The processor 1180 may execute the instructions stored in the memory 1170. The processor 1180 may be a single processor or a plurality of processors.

What is claimed is:

1. An apparatus for simultaneously controlling vehicle heading and tire alignment, the apparatus comprising:
at least one memory configured to store instructions; and
at least one processor configured, by executing the instructions, to:
park a vehicle at a target parking position within a target parking zone, based on vehicle state information and parking environment information, by generating at least one parking path for parking the vehicle;
determine whether to perform on-center control on the vehicle, based on whether the vehicle is capable of reaching the target parking position via a final reverse path among the at least one parking path;
obtain an on-center alignment time of a steering wheel based on whether the vehicle is capable of reaching the target parking position;
calculate a target heading that represents a difference between an exit direction from the target parking zone and a longitudinal direction of the vehicle;
calculate a heading change amount of the vehicle until an on-center alignment time of the steering wheel, based on a current yaw rate of the vehicle; and
perform the on-center control according to a reverse path for on-center alignment, based on the heading change amount and the target heading.

2. The apparatus of claim 1, wherein the at least one processor is further configured to:
determine whether the vehicle is capable of reaching a lateral position within a preset lateral error range from the target parking position in the target parking zone.

3. The apparatus of claim 1, wherein the at least one processor is further configured to:
obtain the on-center alignment time based on a first steering speed until the steering wheel reaches on-center alignment.

4. The apparatus of claim 3, wherein the first steering speed is an average steering speed from a current time point to a time point at which the steering wheel reaches on-center alignment.

5. The apparatus of claim 1, wherein the at least one processor is further configured to:
calculate the heading change amount by multiplying the current yaw rate by the on-center alignment time.

6. The apparatus of claim 1, wherein the at least one processor is further configured to:
include an on-center condition of the steering wheel in the vehicle state information; and
generate the reverse path for on-center alignment based on the vehicle state information and the parking environment information.

7. The apparatus of claim 1, wherein the at least one processor is further configured to:
perform the on-center control when the heading change amount is greater than or equal to the target heading.

8. The apparatus of claim 7, wherein the at least one processor is further configured to:
stop the executing of parking of the vehicle; and
perform the on-center control when the heading change amount is greater than or equal to the target heading.

9. The apparatus of claim 2, wherein the at least one processor is further configured to:
perform a second lateral control based on a remaining distance to a parking end point within the target parking zone, when it is determined that the vehicle is not capable of reaching a lateral position range via the final reverse path.

10. The apparatus of claim 9, wherein the at least one processor is further configured, when performing the second lateral control, to:
include a current lateral error of the vehicle and the remaining distance in the vehicle state information when the remaining distance is greater than or equal to a preset distance; and
perform the second lateral control by generating a second reverse path based on the vehicle state information and the parking environment information.

11. The apparatus of claim 9, wherein the at least one processor is further configured, when performing the second lateral control, to:
perform a S-motion lateral control to park the vehicle when the remaining distance is less than or equal to a preset distance.

12. The apparatus of claim 11, wherein the at least one processor is further configured, by performing the second lateral control, to:
determine a maximum steering angle for the S-motion lateral control based on a distance to a left or right vehicle within the target parking zone.

13. A method for simultaneously controlling vehicle heading and tire alignment, the method comprising:
parking a vehicle at a target parking position within a target parking zone, based on vehicle state information and parking environment information, by generating at least one parking path for parking the vehicle;
determining whether to perform on-center control on the vehicle, based on whether the vehicle is capable of reaching the target parking position via a final reverse path among the at least one parking path;
obtaining an on-center alignment time of a steering wheel based on whether the vehicle is capable of reaching the target parking position;
calculating a target heading that represents a difference between an exit direction from the target parking zone and a longitudinal direction of the vehicle;
calculating a heading change amount of the vehicle until an on-center alignment time of the steering wheel, based on a current yaw rate of the vehicle; and
performing the on-center control according to a reverse path for on-center alignment, based on the heading change amount and the target heading.

14. The method of claim 13, wherein determining whether to perform the on-center control comprises:
determining whether the vehicle is capable of reaching a lateral position within a preset lateral error range from the target parking position in the target parking zone.

15. The method of claim 13, wherein obtaining the on-center alignment time comprises:
obtaining the on-center alignment time based on a first steering speed until the steering wheel reaches on-center alignment.

16. The method of claim 13, wherein calculating the heading change amount comprises:
calculating the heading change amount by multiplying the current yaw rate by the on-center alignment time.

17. The method of claim 13, wherein performing the on-center control comprises:
including an on-center condition of the steering wheel in the vehicle state information; and
generating the reverse path for on-center alignment based on the vehicle state information and the parking environment information.

18. The method of claim 13, wherein performing the on-center control comprises:
performing the on-center control based on a determination that the heading change amount is greater than or equal to the target heading.

19. The method of claim 18, wherein performing the on-center control comprises:
stopping the executing of parking of the vehicle; and
performing the on-center control based on a determination that the heading change amount is greater than or equal to the target heading.

20. The method of claim 14, further comprising:
performing a second lateral control based on a remaining distance to a parking end point within the target parking zone, based on a determination that the vehicle is not capable of reaching the lateral position range via the final reverse path.
